(19) United States
(12) Patent Application Publication
(10) Pub. No.: US 2026/0296552 A1
(43) Pub. Date: Oct. 1, 2026

(54) COLLISION ENERGY DISSIPATION DEVICE FOR A VEHICLE

(71) Applicant: Jason Bare, Gerrardstown, WV (US)

(72) Inventor: Jason Bare, Gerrardstown, WV (US)

(21) Appl. No.: 19/096,974

(22) Filed: Apr. 1, 2025

(51) Int. Cl. B62D 21/15

(52) U.S. Cl. CPC B62D 21/155; B62D 21/157

(57) ABSTRACT

An energy dissipation device for dissipating energy imparted from a collision with a vehicle includes an impact member configured to mount to a perimeter of a body of the vehicle, a frame configured to mount to an underside of the body, and a plurality of energy transfer members movably mounted in the frame. The frame has an engagement portion lying adjacent to and extending inwardly from an inner side of the impact member. The energy transfer members are positioned along a path extending along a length of the engagement portion. Adjacent energy transfer members are positioned near enough to each other along the path that the adjacent energy transfer members may be moved to collide with each other.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to energy dissipation devices and more particularly pertains to a new energy dissipation device for dissipating energy imparted from a collision with a vehicle.

### (2) Description of Related Art Including Information Disclosed Under 37 CFR 1.97 and 1.98

The prior art discloses myriad energy dissipation devices which rely on springs, air bladders, or other components which substantially deform to absorb and dissipate energy caused by a collision with a vehicle. However, the prior art fails to describe such a device in which separated components mounted below the vehicle are made to collide in a chain reaction when an impact member mounted to an exterior of the vehicle is impacted with sufficient force such that energy from the impact is dissipated via the several collisions of the chain reaction.

### (h) BRIEF SUMMARY OF THE INVENTION

An embodiment of the disclosure meets the needs presented above by generally comprising an impact member configured to mount to a perimeter of a body of a vehicle, a frame configured to mount to an underside of the body, and a plurality of energy transfer members movably mounted in the frame. The frame has an engagement portion lying adjacent to and extending inwardly from an inner side of the impact member. The energy transfer members are positioned along a path extending along a length of the engagement portion. Adjacent energy transfer members are positioned near enough to each other along the path that the adjacent energy transfer members may be moved to collide with each other.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top view of an energy dissipation device according to an embodiment of the disclosure.

FIG. 2 is a side view of an embodiment of the disclosure.

FIG. 3 is a front view of an embodiment of the disclosure.

FIG. 4 is a cross-sectional view of an embodiment of the disclosure showing energy transfer members within the portion of the frame circled by Window 4 in FIG. 1.

FIG. 5 is a cross-sectional view of an embodiment of the disclosure from the same perspective of FIG. 4 in which a frame and the energy transfer members are depicted to collide as part of a chain reaction caused by an impact to an impact member of the embodiment.

### (j) DETAILED DESCRIPTION OF THE INVENTION

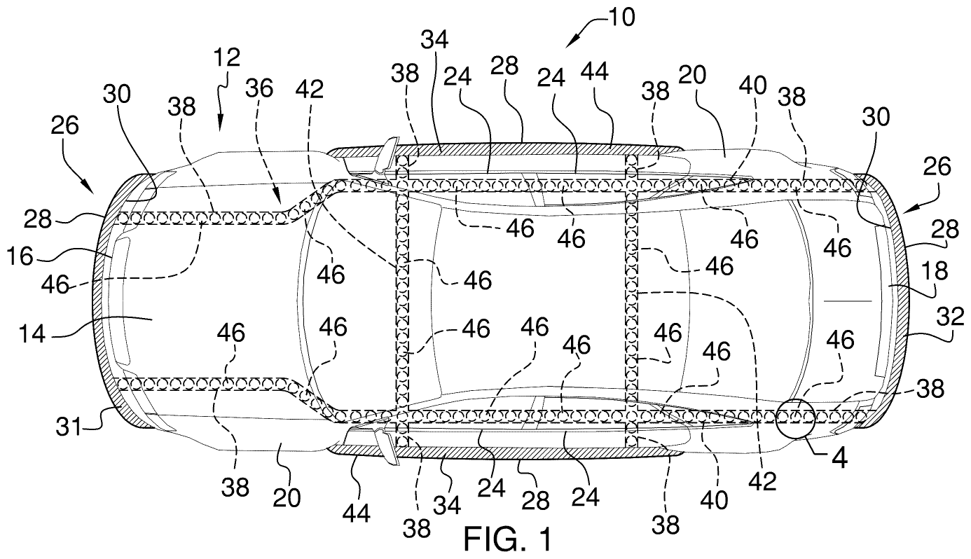

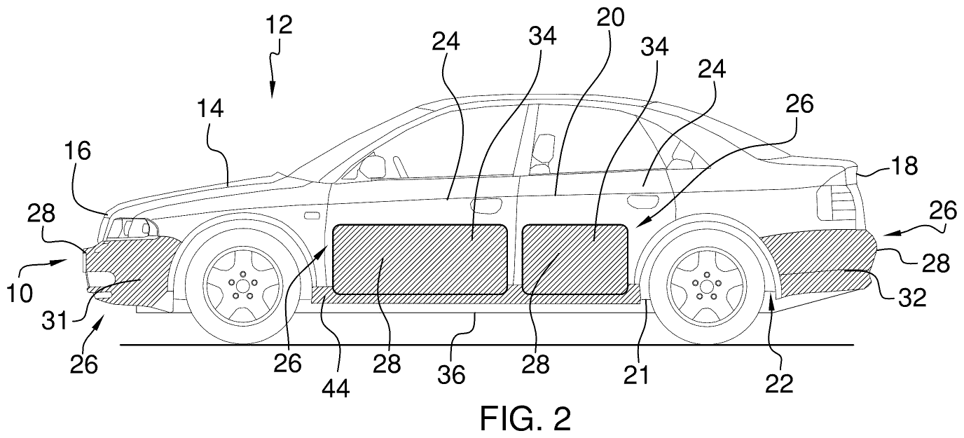

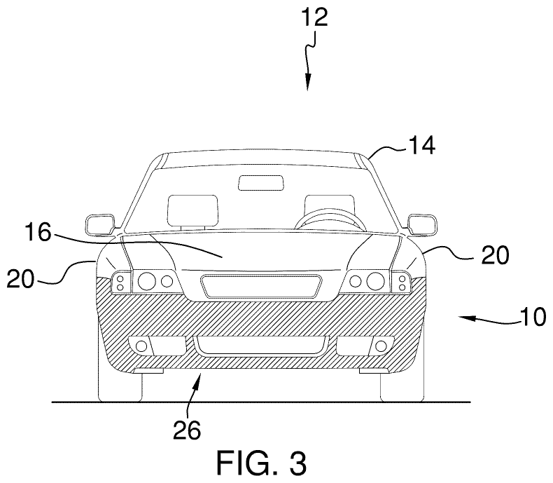

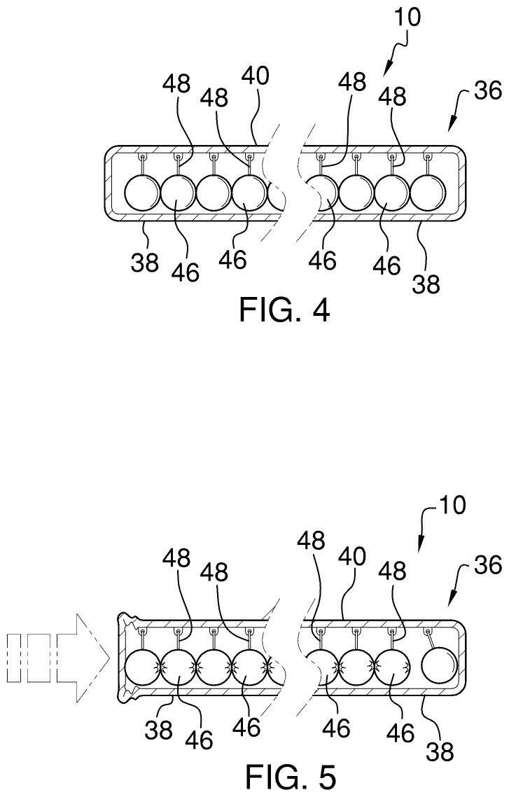

With reference now to the drawings, and in particular to FIGS. 1 through 5 thereof, a new energy dissipation device embodying the principles and concepts of an embodiment of the disclosure and generally designated by the reference numeral 10 will be described.

As best illustrated in FIGS. 1 through 5, the energy dissipation device 10 generally comprises a plurality of impact members 26 configured to mount to a perimeter (including a front side 16, a rear side 18, and a pair of lateral sides 20) of a body 14 of a vehicle 12, a frame 36 configured to mount to an underside 22 of the body 14, and a plurality of energy transfer members 46 movably mounted to the frame 36 such that at least a subset of the energy transfer members 46 may be urged to collide in a chain reaction initiated by an impact to an outer side 28 of one of the impact members 26. The vehicle 12 may be an automobile, but may also be a railcar, a tram, a trailer, or the like.

The plurality of impact members 26 includes a front impact member 31, a rear impact member 32, and a plurality of lateral impact members 34. The front impact member 31 mounts to the front side 16 of the body 14 by having a shape which conforms to a shape of the front side 16 of the body 14. Interlocking portions of the front impact member 31 and the front side 16 of the body 14 may thus retain the front impact member 31 on the body 14 of the vehicle 12. The rear impact member 32 similarly mounts to the rear side 18 of the body 14 of the vehicle 12 by having a shape which conforms to a shape of the rear side 18 of the vehicle 12. In other embodiments, the front impact member 31 and the rear impact member 32 may be attached via weldments, adhesives, magnets, threaded fasteners, or any other suitable fastener. The front impact member 31 and the rear impact member 32 also may be integrally formed with the body 14 of the vehicle 12 or with the front side 16 and the rear side 18 respectively. The front impact member 31 and the rear impact member 32 may have any of a variety of shapes and may have apertures to permit airflow therethrough to a grill of the vehicle 12 or similar.

Each lateral impact member 34 mounts to an associated door 24 of a plurality of doors 24 of the body 14 of the vehicle 12, which are positioned on associated lateral sides 20 of the pair of lateral sides 20 of the body 14, via magnetic attraction. Each lateral impact member 34 comprises a magnetic material which magnetically attaches the lateral impact member 34 to a ferromagnetic material of the associated door 24. The entirety of each lateral impact member 34 may comprise the magnetic material, or magnets may be embedded or housed in an enclosing structure such as a housing, a casing, or the like. The lateral impact members 34 may thus be removed from the associated doors 24 via application of a force sufficient to overcome the magnetic attraction between the lateral impact members 34 and the associated doors 24. The lateral impact members 34 may be removably mounted via latches, threaded fasteners, clamps, or the like in other embodiments. The lateral impact members 34 also may be fixedly attached to or integrally formed with the associated doors 24, such as via weldments, threaded fasteners, molding, or the like. In some embodiments, one or more of the lateral impact members 34 may be attached to a wall portion of an associated lateral side 20 of the body 14 rather than one of the doors 24.

The frame 36 has a plurality of engagement portions 38, each of which lies adjacent to and extends inwardly from an inner side 30 of an associated impact member 26 of the plurality of impact members 26. The engagement portions 38 form a pair of longitudinal members 40 and a pair of lateral members 42. Each longitudinal member 40 extends from the front impact member 31 to the rear impact member 32. Each lateral member 42 extends between the lateral sides 20 of the body 14 of the vehicle 12 from one lateral impact member 34 to another lateral impact member 34 positioned opposite the one lateral impact member 34. Thus, each longitudinal member 40 of the frame 36 is defined by an engagement portion 38 which lies adjacent to and extends from the front impact member 31 and another engagement portion 38 which lies adjacent to and extends from the rear impact member 32. Similarly, each lateral member 42 of the frame 36 is defined by engagement portions 38 which lie adjacent to and extend from their associated lateral impact members 34.

The frame 36 attaches to the body 14 of the vehicle 12 via a pair of frame attachment members 44, each of which extends around an associated lower lateral edge 21 of the body 14 of the vehicle 12 and is coupled to the pair of lateral members 42 of the frame 36. The frame attachment members 44 may be clamped, welded, latched, or otherwise attached to the body 14. The frame 36 may, however, attach to the body 14 of the vehicle 12 via any of myriad means, such as weldments to the underside 22 of the body 14, threaded fasteners, clamps, magnets, or the like.

The frame 36 may be attached directly to the front impact member 31 and the rear impact member 32 but need not be. The engagement portions 38 are, however, positioned near the associated impact members 26 such that, when one of the impact members 26 is impacted on the outer side 28 of the impact member 26, energy from the impact propagates through the associated engagement portion 38. The engagement portions 38 may, for example, lie in abutment with the associated impact members 26 or may be spaced a nominal distance from the associated impact members 26 which is traversed by the associated impact members 26 upon being impacted as described. With respect to the lateral impact members 34, the positioning of the associated engagement members such that energy propagates in this manner may only occur when the associated door 24 is shut.

The energy transfer members 46 are mounted in the frame 36 along a plurality of paths. Each path extends along a length of an associated engagement portion 38 of the plurality of engagement portions 38. The energy transfer members 46 are positioned such that adjacent energy transfer members 46 along each path are in abutment with each other but may be spaced such that adjacent energy transfer members 46 may be moved to collide with each other. Each energy transfer member 46 has a spherical shape but may have any other suitable shape such as a polygonal prism or an irregular shape. The energy transfer members 46 are suspended within the frame 36 via pendulum arms 48 such that they pivotably swing with respect to the frame 36. However, the energy transfer members 46 may be slidably coupled within the frame 36 or otherwise movably coupled via suitable linkages.

In use, the energy dissipation device 10 is mounted to or constructed with the body 14 of the vehicle 12. When a hazard impacts the outer side 28 of one of the impact members 26 with sufficient force, energy from the impact is transferred to the energy transfer members 46 in the associated engagement portion 38 of the frame 36. During this process, the impacted impact member 26, the frame 36, and the energy transfer members 46 may be deformed or fractured such that energy transfers as described. The energy transfer members 46 of the associated engagement portion 38 of the frame 36 thereby collide in a chain reaction of impacts, dissipating at least a portion of the energy which is imparted on the impacted impact member 26 in the form of kinetic energy applied to the energy transfer members 46 and thereafter into heat via friction and damping forces which occur with each collision of adjacent energy transfer members 46. The dissipation of energy lessens damage to the body 14 of the vehicle 12 and lessens the energy that would otherwise dissipate through the vehicle 12 to occupants therein.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An energy dissipation device for use on a body of a vehicle, the energy dissipation device comprising:
an impact member configured to mount to a perimeter of the body;
a frame configured to mount to an underside of the body, the frame having an engagement portion lying adjacent to and extending inwardly from an inner side of the impact member; and
a plurality of energy transfer members movably mounted in the frame, the plurality of energy transfer members being positioned along a path extending along a length of the engagement portion, adjacent energy transfer members of the path being positioned near enough to each other that the adjacent energy transfer members may be moved to collide with each other.

2. The energy dissipation device of claim 1, wherein:
the impact member is one of a plurality of impact members configured to mount to a perimeter of the body;
the engagement portion is one of a plurality of engagement portions, each engagement portion of the plurality of engagement portions lying adjacent to and extending inwardly from an inner side of an associated impact member of the plurality of impact members; and
the plurality of energy transfer members is positioned along a plurality of paths, each path of the plurality of paths extending along a length of an associated engagement portion of the plurality of engagement portions, adjacent energy transfer members of each path being positioned near enough to each other that the adjacent energy transfer members may be moved to collide with each other.

3. The energy dissipation device of claim 2, wherein the plurality of impact members includes a front impact member configured to mount to a front side of the body and a rear impact member configured to mount to a rear side of the body.

4. The energy dissipation device of claim 3, wherein the front impact member has a shape such that the front impact member is configured to conform to a shape of the front side of the body.

5. The energy dissipation device of claim 3, wherein the rear impact member has a shape such that the rear impact member is configured to conform to a shape of the rear side of the body.

6. The energy dissipation device of claim 3, wherein the frame comprising a pair of longitudinal members which extends from the front impact member to the rear impact member.

7. The energy dissipation device of claim 2, wherein the plurality of impact members includes a plurality of lateral impact members, each lateral impact member of the plurality of lateral impact members being configured to mount to an associated lateral side of a pair of lateral sides of the body.

8. The energy dissipation device of claim 7, wherein each lateral impact member of the plurality of lateral impact members is configured to be removable from the body.

9. The energy dissipation device of claim 7, wherein each lateral impact member of the plurality of lateral impact members comprising a magnetic material for removably mounting the lateral impact member to the body.

10. The energy dissipation device of claim 7, wherein the frame comprises a pair of lateral members, each lateral member of the pair of lateral members being configured to extend between the pair of lateral sides of the vehicle from one associated lateral impact member of the plurality of lateral impact members to another associated lateral impact member of the plurality of impact members.

11. The energy dissipation device of claim 1, wherein the energy transfer members are positioned in abutment with each other along the path.

12. The energy dissipation device of claim 1, wherein each energy transfer member of the plurality of energy transfer members has a spherical shape.

13. The energy dissipation device of claim 1, further comprising a plurality of pendulum arms, each pendulum arm of the plurality of pendulum arms pivotably coupling an associated energy transfer member of the plurality of energy transfer members to the frame.

14. An energy dissipation device for use on a body of a vehicle, the energy dissipation device comprising:
a plurality of impact members configured to mount to a perimeter of the body, the plurality of impact members including a front impact member configured to mount to a front side of the body, a rear impact member configured to mount to a rear side of the body, and a plurality of lateral impact members, each lateral impact member of the plurality of lateral impact members being configured to mount to an associated lateral side of a pair of lateral sides of the body, the front impact member having a shape such that the front impact member is configured to conform to a shape of the front side of the body, the rear impact member having a shape such that the rear impact member is configured to conform to a shape of the rear side of the body, each lateral impact member of the plurality of lateral impact members comprising a magnetic material for removably mounting the lateral impact member to the body;
a frame configured to mount to an underside of the body, the frame having a plurality of engagement portions, each engagement portion of the plurality of engagement portions lying adjacent to and extending inwardly from an inner side of an associated impact member of the plurality of impact members, the frame comprising a pair of longitudinal members which extends from the front impact member to the rear impact member, the frame further comprising a pair of lateral members, each lateral member of the pair of lateral members being configured to extend between the pair of lateral sides of the vehicle from one associated lateral impact member of the plurality of lateral impact members to another associated lateral impact member of the plurality of impact members;
a plurality of energy transfer members movably mounted in the frame, the plurality of energy transfer members being positioned along a plurality of paths, each path of the plurality of paths extending along a length of an associated engagement portion of the plurality of engagement portions, adjacent energy transfer members of each path being positioned in abutment with each other, each energy transfer member of the plurality of energy transfer members having a spherical shape; and
a plurality of pendulum arms, each pendulum arm of the plurality of pendulum arms pivotably coupling an associated energy transfer member of the plurality of energy transfer members to the frame.
